(19) United States
(12) Patent Application Publication
(10) Pub. No.: US 2010/0037762 A1
(43) Pub. Date: Feb. 18, 2010

(54) VALVE DEVICE AND METHOD FOR THE ACTIVATION OF AN ACTUATING DRIVE ACTED UPON WITH PRESSURE MEDIUM BY A POSITION CONTROLLER

(75) Inventors: Thomas KLEEGREWE, Minden (DE); Dieter BINZ, Hirschberg (DE); Stefan TABELANDER, Herford (DE)

Correspondence Address: BUCHANAN, INGERSOLL & ROONEY PC, POST OFFICE BOX 1404, ALEXANDRIA, VA, 22313-1404, US

(73) Assignee: ABB Technology AG, Zurich (CH)

(21) Appl. No.: 12/539,123

(22) Filed: Aug. 11, 2009

(30) Foreign Application Priority Data
Aug. 12, 2008 (DE) 10 2008 038 722.3

(51) Int. Cl. F15B 15/26; G05D 16/04

(52) U.S. Cl. 91/45; 137/505; 137/488; 137/505.15

(57) ABSTRACT

A valve device and method for the activation of an actuating drive, which can be acted upon with a pressure medium by a position controller. The position controller can be acted upon by a working connection of the actuating drive with a pressure medium which can be delivered to the position controller via a feed pressure connection. The valve device includes means for blocking the actuating drive in the event of a failure of the feed pressure. The blocking means includes a pilot-controlled shut-off valve which is arranged in the region of the working connection of the position controller, and a pilot control valve arrangement connected to the feed pressure connection of the position controller to control pressure of the feed pressure connection and cause the pilot-controlled shut-off valve to assume a shut-off position when the feed pressure falls below a defined first limit value.

### RELATED APPLICATION

This application claims priority under 35 U.S.C. §119 to German Patent Application No. 10 2008 038 722.3 filed in Germany on Aug. 12, 2008, the entire content of which is hereby incorporated by reference in its entirety.

### FIELD

The present disclosure relates to a valve device for the activation of an actuating drive. According to an exemplary embodiment as provided herein, the actuating drive can be acted upon with a pressure medium by a position controller and be acted upon by a working connection of the actuating drive with the pressure medium, which can be delivered to the position controller via a feed pressure connection. The valve device can be provided with means for blocking the actuating drive in the event of a failure of feed pressure, according to at least one embodiment. The present disclosure also relates to an associated method for the activation of such a valve device and to the position controller itself which comprises this valve device.

### BACKGROUND INFORMATION

Exemplary embodiments of the present disclosure encompass, for example, the position control of actuating or regulating drives. In this case, a desired electrical value is stipulated for a regulating valve which converts this into a working pressure with which, for example, a spring-returned single-acting pneumatic cylinder is acted upon. A displacement sensor can be arranged on the piston rod of such a pneumatic cylinder to measure the actuating travel of the actuating drive in reaction to the action of a pressure medium and feed it back to the control loop. Depending on the stipulation of the desired electrical value, the regulating valve connects the working connection of the actuating drive to a feed pressure connection for acting upon the actuating drive or to a venting connection for venting the actuating drive, to map the stipulated desired value onto the actuating drive. The actuating drive, in turn, serves for operating a fitting, such as a flat slide valve, for example, within a pipeline of a chemical engineering plant.

In the event of a failure of the feed pressure, for example, as a result of a breakaway of the feed pressure line from the feed pressure connection of the position controller, the relevant pressure medium-operated position controllers are to assume a defined position so as to, in the event of this fault, ensure the reliability of the actuating member operated thereby.

It is known that, in the event of the failure of the feed pressure supply, the valve mechanism comes into an initial position which ensures a venting of the connected actuating drive. Venting has the effect that the connected actuating drive is moved into a defined end position via an integrated spring, thus, in turn, completely opening or closing the fitting connected to it. However, special applications require that the fitting or the like connected to the actuating drive maintains its current position if the supply of a feed pressure to the position controller or the electrical signal fails. This requirement has hitherto been a substantial reason for the use of electrical position controllers instead of the pressure medium-operated position controllers relevant to the present disclosure.

A pressure medium-operated position controller is disclosed in EP 1 758 007 A1. This position controller has a valve-like actuating device, by means of which a feed pressure connection, a venting connection and a working connection can be switched variably to generate an operating pressure. To stipulate the desired switching position, the actuating device has two fluid action surfaces which are oriented opposite to one another and which, in each case, delimit a control chamber. The two control chambers are connected to a common control pressure connection, with a throttle device being interposed. Downstream of the two throttle devices, each control chamber is connected to a venting port. The control valve device can control the two venting ports and also close them simultaneously. This symmetrical set-up with respect to the two fluid action surfaces, along with activation via a commonly assigned control pressure connection, ensures that the fluidic actuating forces acting on the control device when the two venting ports are simultaneously closed compensatory to one another, and that a clearly defined position of the actuating device is obtained. There is the possibility, with the venting ports closed, of stipulating a basic position of the actuating device in which the working connection is separated both from the feed connection and from the venting connection. That is, the middle switching position of a 3/3-way valve can be achieved, so that a constant pilot control pressure is maintained, to thereby give the position controller a blocking fail-safe behavior. The blocking fail-safe behavior is achieved by means of a corresponding electrical activation of the position controller.

The disadvantage of this technique, however, is the separate activation required for this. For instance, one separate electronic unit, together with cabling, is required according to safety stipulations, to provide an independent emergency activation of the position controller. Overall, this technical solution for providing a definedly blocking fail-safe behavior as a result of the failure of pressure medium seems to be highly complicated. Moreover, in statistical terms, the extra outlay with regard to components and to cabling increases the susceptibility to faults.

### SUMMARY

An exemplary embodiment of the present disclosure provides a valve device for actuating an actuating drive via a pressure medium by a position controller, which is configured to be acted upon by a working connection of the actuating drive via the pressure medium which is deliverable to the position controller via a feed pressure connection. The exemplary valve device comprises means for blocking the actuating drive in the event of a failure of the feed pressure. The means for blocking the actuating drive in the event of a failure of the feed pressure comprises a pilot-controlled shut-off valve which is arranged in a region of the working connection of the position controller and which is configured to assume a shut-off position. The means for blocking the actuating drive in the event of a failure of the feed pressure comprises a pilot control valve arrangement connected to the feed pressure connection of the position controller to be pressure-controlled thereby, the pilot control valve arrangement being configured to cause the pilot-controlled shut-off valve to assume the shut-off position when the feed pressure of the feed pressure connection falls below a defined first limit value.

An exemplary embodiment method of activating an actuating drive which is acted upon with pressure medium by a position controller, which is acted upon by a working connection of the actuating drive with the pressure medium that is deliverable to the position controller via a feed pressure connection, wherein, to block the actuating drive in the event of a failure of the feed pressure. The method comprises transferring a pilot-controlled shut-off valve arranged in a region of the working connection of the position controller into a closing position when a pilot control valve arrangement connected to the feed pressure connection of the position controller and pressure-controlled thereby is operated after the feed pressure falls below a defined first limit value.

An exemplary embodiment of the present disclosure provides a device configured to actuate an actuating drive. The exemplary device comprises a position controller configured to actuate the actuating drive via a pressure medium, and configured to be acted upon by a working connection of the actuating drive via the pressure medium which is deliverable to the position controller via a feed pressure connection. The exemplary device also comprises means for blocking the actuating drive in the event of a failure of the feed pressure. The means for blocking the actuating drive in the event of a failure of the feed pressure comprises a pilot-controlled shut-off valve which is arranged in a region of the working connection of the position controller and which is configured to assume a shut-off position. In addition, the means for blocking the actuating drive in the event of a failure of the feed pressure comprises a pilot control valve arrangement connected to the feed pressure connection of the position controller to be pressure-controlled thereby, the pilot control valve arrangement being configured to cause the pilot-controlled shut-off valve to assume the shut-off position when the feed pressure of the feed pressure connection falls below a defined first limit value.

### BRIEF DESCRIPTION OF THE DRAWINGS

Additional features, advantages and refinements of the present disclosure are described below in greater detail with reference to an exemplary embodiment illustrated in the drawing, in which:

FIG. 1 shows a schematic illustration of a block diagram of an exemplary valve device for the activation of an actuating drive that is acted upon with a pressure medium by a position controller, according to at least one embodiment.

### DETAILED DESCRIPTION

Exemplary embodiments of the present disclosure provide a valve device and a method for the activation of a pressure medium-operated position controller, which ensure a defined blocking of the fail-safe behavior as a result of the failure of a pressure medium.

An exemplary embodiment of the present disclosure provides that, in order to block an actuating drive, which can be downstream of a position controller, in the event of a failure of the feed pressure, a pilot-controlled shut-off valve, can be implemented. The pilot-controlled shut-off valve can be arranged in the region of a working connection of the position controller, and by means of a pilot control valve arrangement that is connected to a feed pressure connection of the position controller and pressure-controlled thereby, can assume the shut-off position when the feed pressure falls below a defined first limit value.

An advantageous aspect of various exemplary embodiments is that they can be configured to function purely mechanically. That is, electronic components, such as sensors, a signal processing device and cabling, are rendered unnecessary. An exemplary valve device according to the present disclosure can be integrated in a space-saving way within a position controller or can be designed as a part for mounting onto a position controller in the region of the pressure medium connections of the position controller. By means of the latter-mentioned embodiment, the valve device according to the disclosure can even be retrofitted on existing position controllers.

According to an exemplary embodiment, the pilot control valve arrangement can include disclosure comprises a spring-loaded venting valve which, under the control of an integrated closing spring, can open as soon as the feed pressure falls below the defined first limit value. With the opening of the venting valve, the pilot control pressure of the shut-off valve can be conducted (passed) into the atmosphere, so that the shut-off valve itself changes to the closing position. The desired blocking of the working connection toward the actuating drive can thereby be achieved. According to an exemplary embodiment, the valve technique can be configured such that active action with pressure medium for blocking the actuating drive is not necessary, but, instead, blocking is achieved reliably in safety terms by means of closing springs integrated into the valve technique.

According to an exemplary embodiment, the shut-off valve can be opened again as soon as the feed pressure at the feed pressure connection of the position controller meets the required value again, that is to say overshoots a second limit value. Accordingly, within the framework of the pilot control valve arrangement, a spring-loaded aerating valve can be provided which, under the control of an integrated closing spring, opens as soon as the feed pressure rises above the second limit value, to transfer the pilot control pressure from the feed pressure connection to the shut-off valve, so that the shut-off valve thereupon changes to the open position, and an activation of the actuating drive by the position controller is permitted again.

According to an exemplary embodiment, with consideration to suitable dimensioning of the integrated closing spring, the first limit value of the venting valve can be set lower than the second limit value of the aerating valve. The interval between the two limit values makes it possible for the shut-off valve to open or close in a defined way in spite of any pressure fluctuations in the region of the limit pressure. Such a defined interval can prevent the situation where constantly changing valve positions occur in the limit value range, thus subjecting the valve mechanism to high load and having adverse reactions on the control cycle. In this respect, with regard to an exemplary valve device of the present disclosure, it is proposed that the first limit value can be dimensioned to be 5 to 10% lower than the second limit value, for example. As a result, on the one hand, a sufficiently large interval between the first and the second limit value is implemented, so that switching reliability is afforded; on the other hand, a sufficiently rapid and exact switching reaction can be triggered.

According to an exemplary embodiment, the venting valve, as well as the aerating valve, if present, can have such a steep stroke/pressure characteristic curve that a change in pressure of less than 0.2 bar, for example, is sufficient to release the full valve cross section. Owing to this very steep stroke/pressure characteristic curve, a rapid binary switching behavior of the pilot control valve arrangement can be achieved. This arrangement is also advantageous if the valve seat cross sections present in the pilot control valve arrangement are so much smaller than the diameter of the corresponding operating elements that even the maximum feed pressure does not lead to unwanted maloperation. According to an exemplary embodiment, the operating element for implementing these dimensional conditions can be designed as a diaphragm, for example. When the limit value is reached, the diaphragm can compress the closing spring, with the result that the duct toward the shut-off valve is opened.

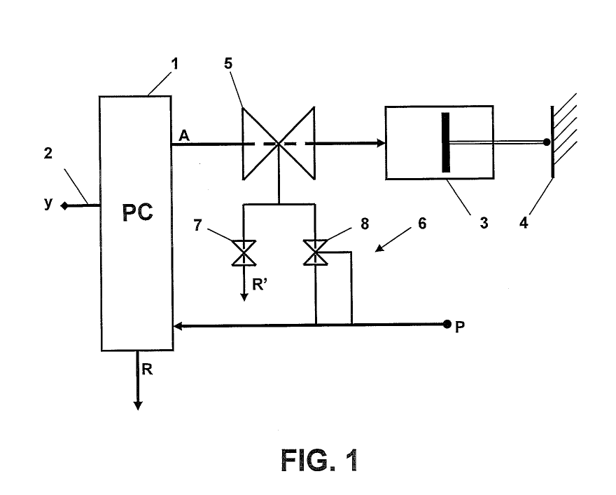

FIG. 1 illustrates a block diagram of an exemplary valve device for the activation of an actuating drive that can be acted upon with a pressure medium by a position controller, according to at least one embodiment. As illustrated in the example of FIG. 1, a position controller (PC) 1 includes an electrical signal input 2, by means of which an actuating value y generated by a control loop can be stipulated by the position controller 1. The position controller I can be supplied with compressed air via a feed pressure connection P. Furthermore, a venting connection R can be provided on the position controller 1, so that, according to the actuating value y, a pressure rise by means of an inflow from the feed pressure connection P or a pressure reduction by means of the outflow of pressure medium through the venting connection R can be brought about at a working connection A.

The working connection A of the position controller 1 acts upon an actuating drive 3. The actuating drive 3 can generate, by the action of a pressure medium, an adjustment travel for a fitting 4, for example.

According to an exemplary embodiment, a valve device for blocking the actuating drive 3 in the event of a failure of the feed pressure can be arranged between the working connection A of the position controller I and the pressure medium connection of the actuating drive 3. The valve device can be an integral component of the position controller 1.

The valve device includes a shut-off valve 5, which can be designed, for example, in the manner of a pneumatically pilot-controlled 2/2-way valve of a normally closed type. The shut-off valve 5 can be activated by a pilot control valve arrangement 6. The pilot control valve arrangement 6 can be fed and also activated via the feed pressure connection P of the position controller 1.

According to an exemplary embodiment, to activate the pilot control valve arrangement 6, a spring-loaded venting valve 7 can be connected via a control pressure line to the feed pressure connection P. The spring-loaded venting valve 7 can open under the control of an integrated closing spring as soon as the pressure at the feed pressure connection P falls below a first limit value, such as 1.4 bar, for example. Consequently, the control pressure can flow out of the pilot control of the shut-off valve 5 via the venting connection R′ to the atmosphere, so that the shut-off valves changes to its closing position. The result of this is that the actuating drive 3 is blocked, that is, the connected fitting 4 remains in its current position.

Furthermore, the pilot control valve arrangement 6 can include a spring-loaded aerating valve 8 which likewise possesses an integrated closing spring. According to an exemplary embodiment, the aerating valve 8 can open as soon as the feed pressure rises above a second limit value, such as 1.5 bar, for example. Consequently, pilot control pressure from the feed pressure connection P can be transferred to the shut-off valve 5, so that the shut-off valve 5 changes to the open position. The effect of this is that the position controller 1 can carry out an action upon the actuating drive 3 with the pressure medium.

The operation of the pilot control valve arrangement 5 counter to a closing spring force makes it possible, by a selection of the correspondingly strong closing spring, to define a respective limit value for the venting valve 7 and aerating valve 8, which limit values are different. Therefore, an unequivocal switching behavior can be implemented. In this exemplary embodiment, the venting valve opens at a first limit pressure of 1.4 bar; the aerating valve 8 opens at a second limit pressure of 1.5 bar. The first and second limit pressure values are examples, and the present disclosure is not limited to these values.

The present disclosure is not restricted to the exemplary embodiments described above. On the contrary, modifications of the exemplary embodiments described above may also be envisaged and are covered by the scope of protection of the following claims. Thus, for example, it is also possible, by means of the actuating drive acted upon with the pressure medium, to operate machine elements other than fittings, such as, for example, a tool or work piece carriers of a handling device.

The present disclosure also provides a method of activating an actuating drive. The exemplary method includes operations corresponding to the functional characteristics of any of the above-described exemplary embodiments.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

1 Position controller (PC)
2 Signal input
3 Actuating drive
4 Fitting
5 Shut-off valve
5 Pilot control valve arrangement
7 Venting valve
8 Aerating valve
9 Feed pressure connection
A Working connection
R Venting connection
y Actuating value (electrical)

What is claimed is:

1. A valve device for actuating an actuating drive via a pressure medium by a position controller, which is configured to be acted upon by a working connection of the actuating drive via the pressure medium which is deliverable to the position controller via a feed pressure connection, the valve device comprising:
means for blocking the actuating drive in the event of a failure of the feed pressure, wherein the means for blocking the actuating drive in the event of a failure of the feed pressure comprises
a pilot-controlled shut-off valve which is arranged in a region of the working connection of the position controller and which is configured to assume a shut-off position, and
a pilot control valve arrangement connected to the feed pressure connection of the position controller to be pressure-controlled thereby, the pilot control valve arrangement being configured to cause the pilot-controlled shut-off valve to assume the shut-off position when the feed pressure of the feed pressure connection falls below a defined first limit value.

2. The valve device as claimed in claim 1, wherein the pilot control valve arrangement comprises a spring-loaded venting valve having an integrated closing spring, the integrated closing spring being configured to control the spring-loaded venting valve to open as soon as the feed pressure falls below the first limit value, so as to discharge the pilot control pressure of the shut-off valve to a surrounding atmosphere, and control the shut-off valve to change to a closing position.

3. The valve device as claimed in claim 2, wherein the pilot control valve arrangement comprises a spring-loaded aerating valve having an integrated closing spring, the integrated closing spring being configured to control the spring-loaded aearating valve to open as soon as the feed pressure rises above a second limit value, so as to transfer the pilot control pressure from the feed pressure connection to the shut-off valve, and control the shut-off valve to change to an open position.

4. The valve device as claimed in claim 3, wherein, via the dimensioning of the integrated closing spring, the first limit value of the venting valve is set lower than the second limit value of the aerating valve.

5. The valve device as claimed in claim 4, wherein the first limit value is dimensioned 5 to 10 percent lower than the second limit value.

6. The valve device as claimed in claim 3, wherein the venting valve and the aerating valve have a stroke/pressure characteristic curve such that a change in pressure of less than 0.2 bar is sufficient to release a full valve cross section.

7. The valve device as claimed in claim 1, wherein the valve cross sections present in the pilot control valve arrangement are smaller than the diameter of the corresponding operating elements such that a maximum feed pressure does not lead to unwanted maloperation.

8. A method of activating an actuating drive which is acted upon with pressure medium by a position controller, which is acted upon by a working connection of the actuating drive with the pressure medium that is deliverable to the position controller via a feed pressure connection, wherein, to block the actuating drive in the event of a failure of the feed pressure, the method comprising:
transferring a pilot-controlled shut-off valve arranged in a region of the working connection of the position controller into a closing position when a pilot control valve arrangement connected to the feed pressure connection of the position controller and pressure-controlled thereby is operated after the feed pressure falls below a defined first limit value.

9. The method as claimed in claim 8, wherein the operation of the pilot control valve arrangement is carried out counter to a closing spring force by means of which the limit value is defined.

10. A position controller, which is configured to act with the pressure medium upon an actuating drive to cause the actuating drive to operate a fitting and which, to achieve a blocking fail-safe behavior as a result of the failure of the feed pressure, comprises a valve device as claimed in claim 1.

11. A position controller, which is configured to act with the pressure medium upon an actuating drive to cause the actuating drive to operate a fitting and which, to achieve a blocking fail-safe behavior as a result of the failure of the feed pressure, comprises a valve device as claimed in claim 2.

12. A position controller, which is configured to act with the pressure medium upon an actuating drive to cause the actuating drive to operate a fitting and which, to achieve a blocking fail-safe behavior as a result of the failure of the feed pressure, comprises a valve device as claimed in claim 3.

13. A device configured to actuate an actuating drive, the device comprising:
a position controller controller configured to actuate the actuating drive via a pressure medium, and configured to be acted upon by a working connection of the actuating drive via the pressure medium which is deliverable to the position controller via a feed pressure connection; and
means for blocking the actuating drive in the event of a failure of the feed pressure, wherein the means for blocking the actuating drive in the event of a failure of the feed pressure comprises
a pilot-controlled shut-off valve which is arranged in a region of the working connection of the position controller and which is configured to assume a shut-off position, and
a pilot control valve arrangement connected to the feed pressure connection of the position controller to be pressure-controlled thereby, the pilot control valve arrangement being configured to cause the pilot-controlled shut-off valve to assume the shut-off position when the feed pressure of the feed pressure connection falls below a defined first limit value.
